(19) United States
(12) Patent Application Publication
(10) Pub. No.: US 2006/0011521 A1
(43) Pub. Date: Jan. 19, 2006

(54) Patio umbrella with screen room

(76) Inventor: Nick Wu, Irvine, CA (US)

Correspondence Address: Karl F. Milde, Jr., Esq.;MILDE & HOFFBERG, LLP, Suite 460, 10 Bank Street, White Plains, NY, 10606, US

(21) Appl. No.: 11/038,636

(22) Filed: Jan. 20, 2005

Related U.S. Application Data
(60) Provisional application No. 60/584,641, filed on Jul. 1, 2004.

(51) Int. Cl. B07B 1/49

(52) U.S. Cl. 209/399

(57) ABSTRACT

A patio or market umbrella or canopy with a sun shade and detachable screening, which is easy and quick to assemble, and permits the screening to be stored out of the elements when not in use.

### FIELD OF THE INVENTION

The present invention relates to patio umbrellas and canopies for shade, and screening to protect from flying insects.

### BACKGROUND OF THE INVENTION

A number of different manufacturers currently supply products which provide shade and protection from insects. Tenting manufacturers produce a multiple room tent with a screen room, having a floor, four walls of screening, and a shade or screen ceiling. The makers of canopies for outdoor markets, and party caterers offer a screen room with a top canopy and four side walls of screening material. The screen walls are permanently attached to the top, or canopy, and are supplied with vertical zippers opening up to create a doorway into and out of the structure. The manufacturers of these products give ample instructions as to the time and effort it takes to erect one of these screened structures.

U.S. Pat. No. 144,792 describes and early attempt to combine an umbrella and mosquito netting. The construction is described at column 2 lines 2-4, as follows, “To the lower edge of the umbrella is secured a continuous piece of netting or gauze”. This construction is said to provide the advantage of be capable of being “folded together in a very small compass for transportation”. The construction has a number of limitations. Though the patent states that one or two people may occupy the structure, there is no entrance for one to come and go. The structure is dropped over the occupants, or they stoop and pull up an edge of the netting to get into the structure.

The “Zebo” by Zipjack is an attempt to create a simple patio umbrella with walls of screening. Vertical zippers are provided in each wall of screening to create entrances to the screened structure. The screening is permanently attached to the shade canopy. The Zebo is manufactured with rope extending through the center pole and the ribs, and through the height of the screening. The screening may be raised or lowered by a crank which gathers up and releases the rope. When not in use, the screening remains gathered up under the shade canopy, and remains outdoors until the umbrella itself is brought indoors. The gathered screen may collect dirt, and/or provide a foundation for nesting squirrels, birds or insects.

It is an object of the present invention to provide temporary screening for a patio or market umbrella. It is a further object of the invention to provide a simple, easily erected structure that will provide shade and protection from insects for a number of people. It is a further object of the invention to provide screening for a shade structure, which screening may be easily detached from the structure for cleaning, storage, or replacement.

### SUMMARY OF THE INVENTION

These objects, as well as other objects which will become apparent from the discussion that follows, are achieved, in accordance with the present invention, which comprises a patio or market umbrella with detachable screen room. The umbrella may comprise a traditional umbrella framework having a post, a plurality of ribs pivotably connected at one end thereof to the post, and additional framing means for maintaining the ribs at an angle to the post.

Alternatively, the framework may comprise a traditional sun canopy having vertical posts and a plurality of horizontal cross beams attached to the posts. A shade canopy is disposed about, and attached to, the framework. The screen rooms have at least one screening panel, and preferably two, three or four panels, each having a top edge, a bottom edge and two vertical edges. Staking means for securing the bottom edge of the screening panels(s) may be provided on either the inside surface or the outer surface of the screening panel. The screening panels are releasably attached to the canopy. Preferably, the umbrella with screen room has at least two screening panels, joined along their vertical edge, by at a zipper, which may be unzipped to create an entrance to the screen room.

The screening panels may be framed along their edges with denser, more durable fabric material, and the zipper secured to the denser fabric material at the vertical edge. Preferably, the zipper has handles operable from both the inside surface and the outside surface. The screening panels may also have ties for tying back the unzipped screening panels to maintain the entrance to the screen room in an open condition.

To keep the bottom edges of the screening panels from blowing, or otherwise being moved about, the screening panels may have staking means along attached along the bottom edge. The staking means may comprise a staking loop attached to the outer surface of the bottom edge of the screen panel, through which a stake is place, and hammered into the ground. When the screening panels are framed along their edges with denser fabric material, the staking means are preferably secured to the denser material at the bottom edge. Alternatively, the staking means may comprise a pocket on the inside surface of the screen panel, along the bottom edge, into which weights may be placed to “load down” the bottom-edge of the screening panel.

The umbrella with screen room or the present invention is remarkably easy to assemble and take apart, even by a single person, as will be described below.

For a full understanding of the present invention, reference should now be made to the following detailed description of the preferred embodiments of the invention as illustrated in the accompanying drawings.

### BRIEF DESCRIPTION OF THE DRAWINGS

FIG. 1 is a top perspective view of a preferred embodiment of the patio umbrella with screen room of the present invention.

FIG. 2 is a bottom perspective view of the embodiment of the patio umbrella with screen room of FIG. 1, with the screening temporarily removed.

FIG. 3 is a side view of the embodiment of the patio umbrella with screen room of FIG. 2, with the shade portion lowered halfway, preparatory to attaching the screening.

FIG. 4 is a perspective view of the releasable attachment means on the shade portions of the embodiment of the patio umbrella with screen room of FIG. 1.

FIG. 5 is a side view of the zipper fastening of the screen panels.

FIG. 6 is a perspective view of a staking means according to the present invention.

FIG. 7 is an alternative staking means according to the present invention.

### DESCRIPTION OF THE PREFERRED EMBODIMENTS

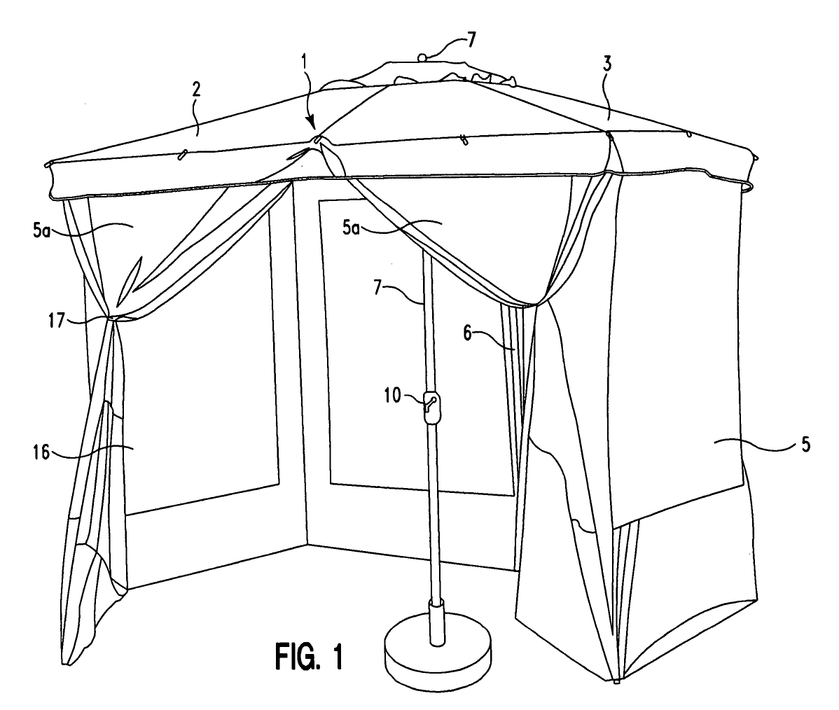

The preferred embodiments of the present invention will now be described with reference to FIGS. 1-6 of the drawings. Identical elements in the various figures are designated with the same reference numerals.

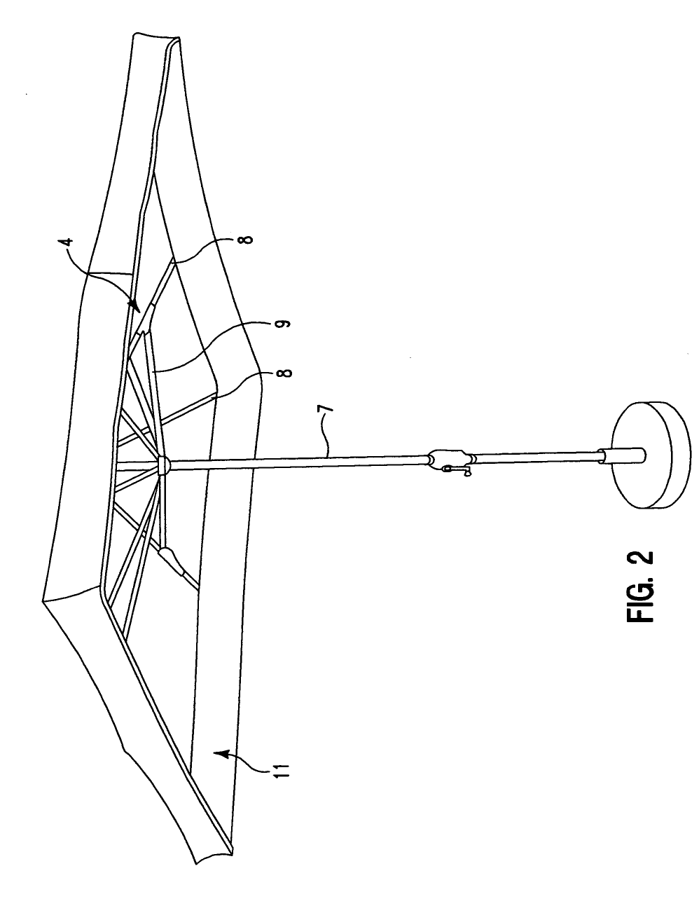

FIG. 1 illustrates the umbrella with screen room, shown generally at 1, of a preferred embodiment of the present invention. The patio umbrella with screen room, 1, in this embodiment, comprises an umbrella, 2, having a shade canopy, 3, and a framework, shown generally at 4 in FIG. 2, for supporting the shade canopy. As shown in FIG. 1, one or more screening panels, 5, may be attached to the shade canopy, such that the panels may be separated along a side of the screen room to form an entrance, and tied back as at 5a, to maintain the entrance in an open condition. As shown in this preferred embodiment the screening panels are generally rectangular, having upper and lower edges, and top and bottom edges. The panels may be framed along their edges with a stronger, more durable and/or dense fabric material.

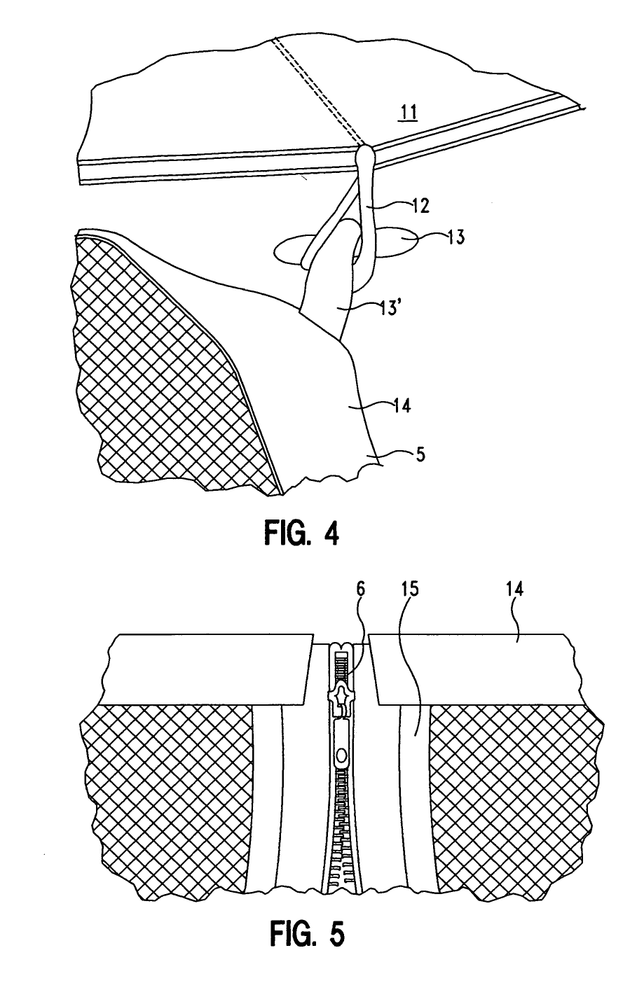

As shown in FIG. 2, the framework, 4, comprises a post, 7, and to a plurality of ribs, 8, with additional framing means, 9, for maintaining the ribs at a predetermined angle to the post. As may be noted, in FIG. 4, the umbrella or canopy and supporting framework is a square shape. There is no limitation the shape of the framework or canopy of the present invention, which adds to existing innovations in patio and market umbrellas. For example, the shade canopy illustrated in FIGS. 1-3 has a two-part construction, permitting air to circulate at the top of the post, but blocking sun or precipitation under the canopy.

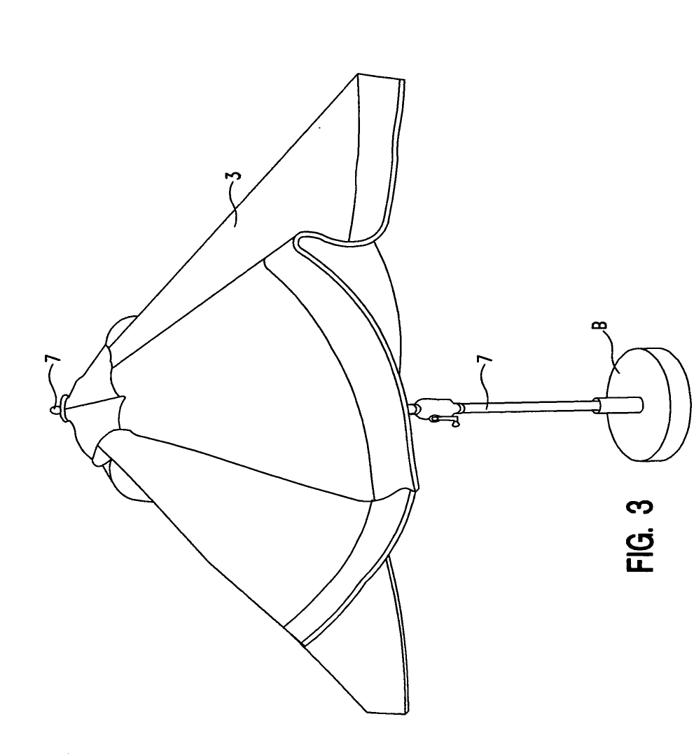

To assemble the umbrella with screen room of this preferred embodiment of the present invention the post is first assembled and placed in a securing base therefore, such as base, B. As is known, the post may be constructed of multiple pieces which snap together. To attach the screening panels to the canopy, that crank, 10, on the post in is turned to lower the canopy about halfway as shown in FIG. 3. As shown in FIG. 4, on the underside of the canopy, 11, are means are releasably attaching the screen portions to the canopy, in this embodiment, fabric loops, 12. Toggles, 13, attached to the fabric framing, 14, at the upper edge of the screening panel, 5, may be placed through the fabric loops, 12, to attach the screening panel to the canopy. To remove the screening panel, the toggles are withdrawn from the loops, to completely separate the screening panel from the canopy. As shown in FIG. 4, the toggle, 13, is secured to the fabric frame by means of the fabric loop 13′, however many alternative constructions may be used to attach the toggle to the screening panel.

FIG. 5 illustrates the joining of two screening panels by a zipper, 6, as viewed from underneath the shade canopy. In this particular embodiment, the two sides of the zipper are attached to the fabric framing means along the vertical edge of two screening panels. When the zipper is moved in a downward direction, the two screening panels are joined. When the zipper is raised, an entrance, 16, into the bug-free space is created. Ties, 17, may be provided, to hold open the entrance. In this preferred embodiment the screen room comprises two screening panels attached by two zippers, 6, which may be used to create entrances at opposite sides of the screen room. There is no limit, except practicality, as to the number of screening panels which may be used with the canopy to create the screen room. The use of multiple screening panels makes it easier to attach them, one at a time, to the canopy, and then zip them together to form the screen room. It should be noted that, in an alternative construction, the screening panels may be releasably secured to the ribs of the umbrella instead of the canopy; however, the simple fabric loop-to-toggle arrangement of the preferred embodiment presents the simplest construction. Once the screening panels have been attached to the canopy, that crank, 10, on the post, 7, may be turned to fully extend the framework and shade canopy attached thereto.

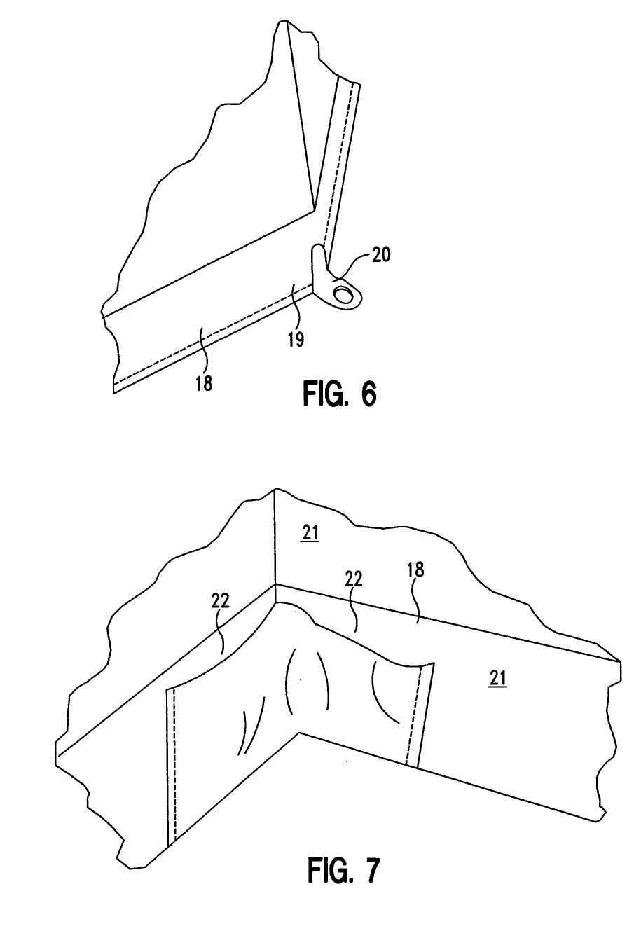

Along the bottom edge of the screening panel are staking means for maintaining the positioning of the screening panel generally perpendicular to the ground. As shown in FIG. 6, when setting up the screen room on grass, the staking means may comprise a staking loop, 20, attached to the fabric frame, 18, at the bottom edge, on the outer surface, 19, of the screening panel. Stakes, not shown, may be driven through the loop and into the ground. The angle of the stake, and/or a small burr on the side of the stake, maintain the staking loop on the stake, near the ground. When setting up the patio or market umbrella with screen room on a wooden deck, or on a concrete surface, alternative staking means may be provided, such as corner pockets, 22, on the inner surface, 21, of the screening panel. Loose sand, sandbags, weights, or even small rocks may be placed in the corner pockets, 22, to keep the bottom edge of the screening panel from being blown to and fro.

There has thus been shown and described a novel patio or market umbrella with detachable screen room which fulfills all the objects and advantages sought therefore. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

What is claimed is:

1. An umbrella with screen room, comprising;
a) a framework comprising
1) a post, and
2) a plurality of ribs, each rib being connected at one end thereof to the post, and
3) framing means for maintaining the ribs at an angle to the post,
b) a canopy of shade producing material, disposed about the framework, and attached to the framework, and
c) at least one screen panel, having top edge, a bottom edges and two vertical edges, and an inner surface and an outer surface, said at least one panel releasably attached to the canopy
d) fastening means on said shade canopy for receiving complementary fastening means on said screening panel, for making releasable attachment of the screening panel to the shade canopy.

2. An umbrella with screen room as in claim 1, having at least two screening panels joined along a vertical edge, by at least one zipper.

3. An umbrella with screen room as in claim 2, wherein the screening panels are framed along their edges with denser material, and the zipper is secured to the denser material at the vertical edge.

4. An umbrella with screen room as in claim 2, wherein the zipper has handles operable from the inner surface and the outer surface.

5. An umbrella with screen room as in claim 2, said screening panels further comprising ties for tying back the unzipped screening panels to open an entrance to the screen room.

6. An umbrella with screen room as in claim 1, further comprising staking means along attached to the screening panel along the bottom edge.

7. An umbrella with screen room as in claim 6, wherein the screening panels are framed along their edges with denser material, and the staking means are secured to the denser material at the bottom edge.

8. An umbrella with screen room as in claim 6, wherein the staking means comprises a staking loop attached to the outer surface of the bottom edge of the screen panel.

9. An umbrella with screen room as in claim 6, wherein the staking means comprises a pocket on the inside surface of the screen panel, along the bottom edge.

10. An umbrella with screen room, comprising:
a) an umbrella, comprising a framework for a shade canopy, a shade canopy, and fastening means for screening panels; and
b) at least one screening panel, having complementary fastening means, for making releasable attachment to the fastening means on the shade canopy.

11. An umbrella with screen room as in claim 10, having at least two screening panels joined along a vertical edge, by at least one zipper.

12. An umbrella with screen room as in claim 12, wherein the screening panels are framed along their edges with denser material, and the zipper is secured to the denser material at the vertical edge.

13. An umbrella with screen room as in claim 12, wherein the zipper has handles operable from the inner surface and the outer surface.

14. An umbrella with screen room as in claim 10, further comprising staking means along attached to the screening panel along the bottom edge.

15. An umbrella with screen room as in claim 14, wherein the screening panels are framed along their edges with denser material, and the staking means are secured to the denser material at the bottom edge.

16. An umbrella with screen room as in claim 14, wherein the staking means comprises a staking loop attached to the outer surface of the bottom edge of the screen panel.

17. An umbrella with screen room as in claim 14, wherein the staking means comprises a pocket on the inside surface of the screen panel, along the bottom edge.

18. An umbrella with screen room comprising;
a) a framework comprising vertical posts and a plurality of horizontal cross beams attached to the posts;
b) a canopy of protective material, disposed about and attached to the framework, and fastening means attached to the shade canopy; and
c) at least one screening panel comprising screening material, and further comprising complementary fastening means for releasably attaching the at least one screen panel to the fastening means of the shade canopy.

19. An umbrella with screen room as in claim 18, wherein the screen panels have a top and bottom horizontal edges and vertical edges therebetween, and zipper means along the vertical edges for attaching the screen panels to form a closed space, and to create entrances to the screen room when unzipped.

20. An umbrella with screen room as in claim 18, further comprising means for staking the at least one screening panel to the ground.
